(19) United States
(12) Patent Application Publication
(10) Pub. No.: US 2009/0015088 A1
(43) Pub. Date: Jan. 15, 2009

(54) Drive for Use in a Motor Vehicle

(76) Inventors: Aram Akopian, Dresden (DE); Matthias benkert, Wurzburg (DE); Benjamin Obst, Spemberg (DE); Stephan Ullrich, Floh-Seligenthal (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/094,576

(22) PCT Filed: Sep. 28, 2006
(86) PCT No.: PCT/EP2006/066857

§ 371 Date: Sep. 24, 2008

(30) Foreign Application Priority Data
Nov. 25, 2005 (DE) 10 2005 056 347.3

(51) Int. Cl. H02K 7/10

(52) U.S. Cl. 310/99

(57) ABSTRACT

In order to find a simple and robust drive solution with a low installation space requirement, a drive (1) for use in a motor vehicle with a motor (2), at least two drive output shafts (16, 16′; 31, 31′) for moving drive output pinions (9, 9′), and a transmission, which is arranged between the motor (2) and the drive output shafts (16, 16′; 31, 31′), for selectively transmitting the drive input movement of the motor (2) to the drive output pinions (9, 9′) is proposed, wherein the transmission has a number of switchable clutches (11, 11′, 14, 14′; 32, 32′, 34, 34′) and at least one switching element (23) for simultaneously changing the transmission capacity of one or more clutches (11, 11′, 14, 14′; 32, 32′, 34, 34′).

### CROSS-REFERENCE TO RELATED APPLICATIONS

This application is a U.S. national stage application of International Application Number PCT/EP2006/066857 filed Sep. 28, 2006, which designates the United States of America, and claims priority to German application number 10 2005 056 347.3 filed Nov. 25, 2005, the contents of which are hereby incorporated by reference in their entirety.

### TECHNICAL FIELD

The invention relates to a drive for use in a motor vehicle, especially for a sliding roof arrangement.

### BACKGROUND

With sliding roof mechanisms it is often necessary to move a number of movable elements independently of each other. It can thus be necessary for example to move a glass panel and a roll-up sunshield or two separate glass panels. In the solutions known from the prior art the usual approach is to employ a separate motor for each of these movements, mostly in the form of an electric motor. As well as requiring a large amount of space, this solution has the further disadvantage of a high outlay in materials required and in manufacturing. At the same time the weight of the drive in the motor vehicle increases with each component needed.

### SUMMARY

According to an embodiment, a simple and robust drive solution requiring little mounting space for arrangements of this type can be provided by a drive for use in a motor vehicle, comprising a motor, with at least two drive shafts for moving drive pinions, and a transmission arranged between the motor and the drive shafts for optional transmission of the drive movement of the motor to the drive pinions, wherein the transmission comprises a number of switchable clutches and at least one switching element for simultaneously changing the transmission capacity of one or more clutches.

According to a further embodiment, clutch sections, of which the transmission capacity can be changed, may be arranged at two points of a motor shaft at a distance from each other. According to a further embodiment, the motor shaft may be arranged coaxially to at least one drive shaft. According to a further embodiment, the motor shaft can be arranged offset to at least one drive shaft. According to a further embodiment, the may comprise a switching element operating with magnetic force.

### BRIEF DESCRIPTION OF THE DRAWINGS

The invention will be described below with reference to exemplary embodiments which are explained in greater detail with the aid of drawings. The drawings, which are simplified, in some cases schematic, diagrams, are as follows:

FIG. 1 an drive according to an embodiment with axial shaft arrangement and a solenoid in a perspective view,

FIG. 2 an drive according to an embodiment with axial drive arrangement and a solenoid in an overhead view,

FIG. 3 a detailed view of a jaw clutch with a fixed and a movable clutch part,

FIG. 4 a perspective view of an drive according to an embodiment with transmission housing,

FIG. 5 an drive according to an embodiment with axial shaft arrangement and two solenoids,

FIG. 6 an drive according to an embodiment with parallel offset shaft arrangement and one solenoid.

### DETAILED DESCRIPTION

Accordingly a drive is provided with a motor, with at least two output shafts for moving drive pinions, and with a transmission arranged between the motor and the output shafts for optional transmission of the drive movement of the motor to the drive pinions, with the transmission featuring a number of switchable clutches and at least one switching element for simultaneously changing the transmission capacity of one or more clutches.

The option of distributing a drive moment of a single, preferably fixed motor to one or more of at least two, preferably fixed drive shafts is thus provided, with the distribution of the drive moment being undertaken as a function of one or more switchable clutches and the transmission capacity of the clutches being defined by at least one actuation system acting as a switching element.

A “drive pinion” in this context is to be understood as any type of drive element. The “optional transmission” of the drive movement can in such cases, as well as an alternate transmission (either to the one or to the other drive pinion) also include a simultaneous transmission (both to the one and also to the other drive pinion).

Therefore, just a single motor is needed to move a number of drive pinions. This greatly reduces the materials and manufacturing outlay for the drive as a whole. It also requires far less installation space. This means that the little space available in a motor vehicle can be exploited especially effectively. When the drive is used for sun roof arrangements this relates especially to the space over the front passengers and underneath the vehicle roof.

Since the use of further motors is not required the cabling outlay is also reduced. In addition only a single motor control device and a single set of components for interference suppression are necessary. Overall this reduces the weight of the drive, which leads to an overall weight reduction of the motor vehicle and thereby also contributes to a reduction in vehicle operating costs.

With its cost-effective switchover of the drive pinions, such a drive according to various embodiments can be used not just with sliding roof arrangements but also with a plurality of other arrangements in a motor vehicle. In a seat adjustment system according to an embodiment, seat surface and seat back can be moved for example with a single motor movement. A folding roof can for example be folded up according to an embodiment from both sides with a single motor.

According to an embodiment the motor has a motor shaft for transmission of its drive movement, which is provided at two locations spaced apart from each other with clutch elements of which the transmission capacity can be changed. In other words those clutch elements of which the transmission capacity can be changed are arranged on the motor shaft. This means that there is direct switching on the motor shaft with the aid of the switching element. The switching is thus undertaken before the drive shaft, so that the drive shafts or the drive pinions do not have to be switched as well. The switching forces and thereby also the switching currents required are thus very small. This means that only a very small number of small, light and low-cost switching elements are needed. A very compact design of the drive can thus be achieved through this construction. Preferably only a single switching device is needed.

According to a further embodiment, one or more clutches can be moved by the at least one switching element axially, i.e. in the longitudinal direction of the drive shaft. This is especially sensible if the motor shaft is arranged coaxially to at least one drive shaft. A switch is then only made in one direction of action which results in a high level of efficiency. The transmission of the drive movement of the motor is undertaken with the aid of the clutch without any great force redirection, so that constructively simple and thus robust and at the same time low-cost clutches can be used.

According to a further embodiment it is however likewise possible for the motor shaft to be arranged offset to at least one drive shaft. If the shafts are then offset in parallel to each other, a transmission of the drive movement of the motor is possible in an especially simple manner, for example by gears with mesh with each other. However it is also possible for the motor shaft to run transverse to one or more drive shafts.

According to another embodiment, a switching element operating with magnetic force may be provided. These types of switching element are especially reliable and are easy to control. Preferably a switching element with an electromagnet is used, which fulfills the function of a solenoid. In such cases different systems can be used for different requirements on the switching element, for example a double solenoid system or a latching push-type solenoid. Instead of such a magnetic switching element a switching element with a servo motor or such like can also be used.

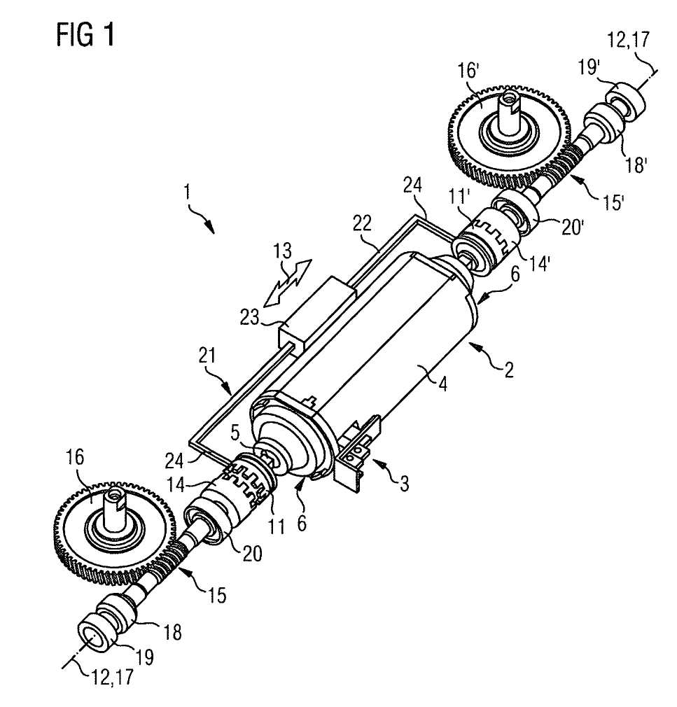

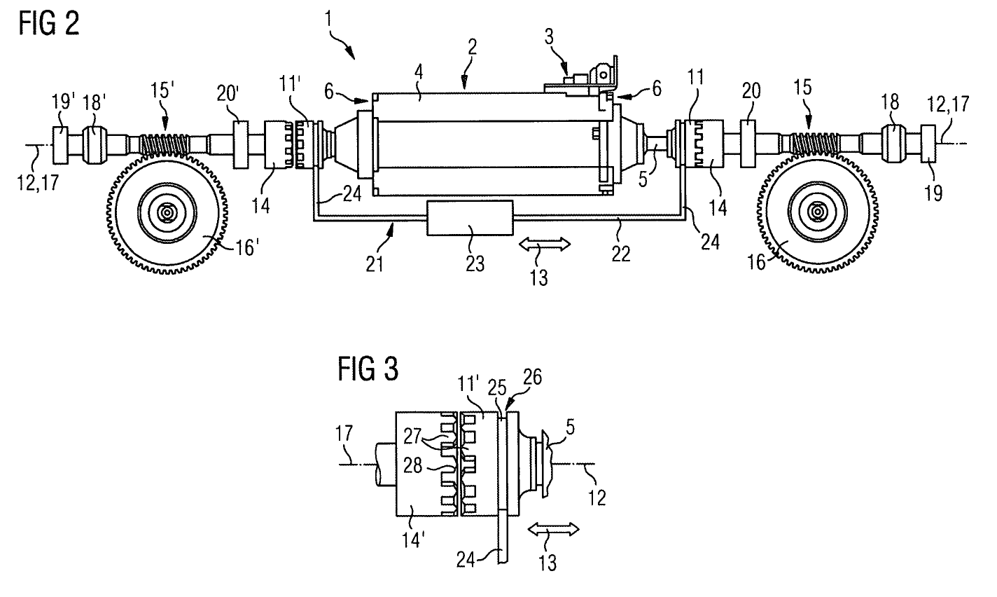

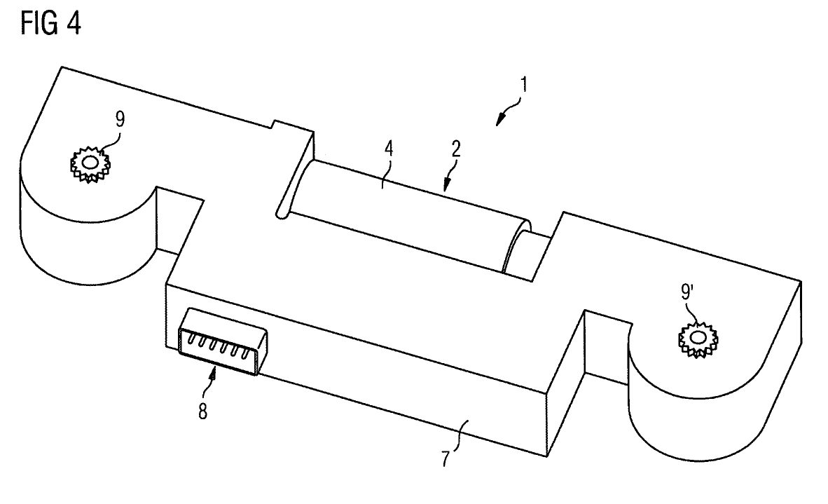

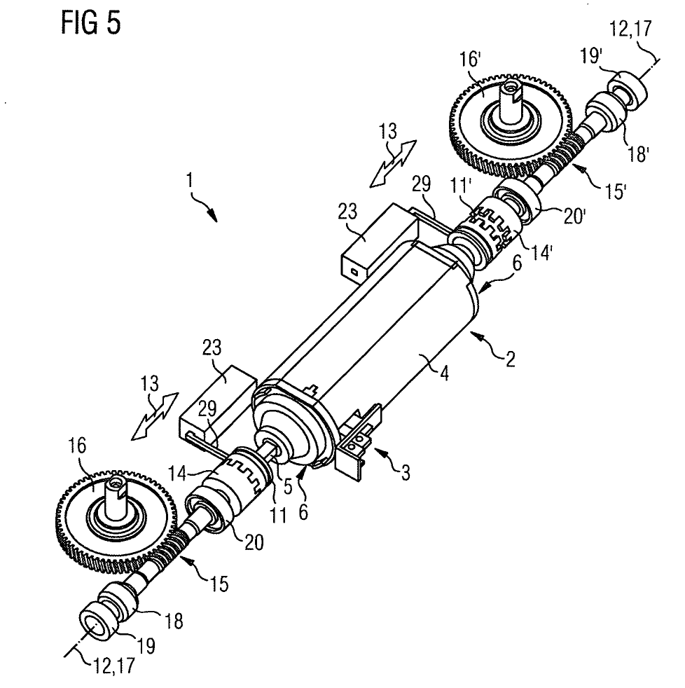

FIG. 1 shows a first exemplary embodiment. The drive 1 for use in a motor vehicle comprises an electric motor 2 with a motor connector 3 which is used for power supply of the electric motor 2. The electric motor 2 comprises a rotor and a stator which are arranged in a motor housing 4. The (single) motor shaft 5 of the electric motor 2 is brought out of both ends 6 of the electric motor 2 as a square shaft. The transmission connected to the motor shaft 5 and described in greater detail below is accommodated in a transmission housing 7 from which a connecting plug for connecting the electric motor 2 or further drive elements to a power source or if necessary a signal source is brought out (cf. FIG. 4). In addition two drive pinions 9, 9′ driven by the electric motor 2 protrude from the transmission housing 7. These drive pinions 9, 9′ are used via so-called hoisting cables for driving a glass panel of a sliding roof arrangement on the one hand and internal roller panel of the sliding roof arrangement on the other hand, but these are however not shown for reasons of clarity.

Arranged in the area of the motor shaft ends is an (inner) clutch part 11, 11′ in each case. The star-shaped clutch section 11, 11′ is one part of a controllable jaw clutch. The clutch section 11, 11′ has a torque-proof connection to the motor shaft 5, meaning that it rotates with the motor shaft 5. At the same time the clutch section 11, 11′ is attached to the motor shaft 5 to allow movement along the longitudinal direction of the motor shaft 12 in the switching direction 13, meaning in other words that it can change its axial position. The inner clutch sections 11, 11′ assigned to the electric motor 2 are thus referred to hereinafter as movable clutch sections 11, 11′.

As counterparts to these movable clutch sections 11, 11′ there are (outer) clutch sections 14, 14′ which are connected in a torque-proof manner and so that they do not move along the fixed output shafts 15, 15′. These outer clutch sections 14, 14′ will thus be referred to hereinafter as fixed clutch sections 14′, and together with the movable clutch sections 11, 11′ assigned to them in each case, form two jaw clutches.

The drive shafts 15, 15′ are used for transmission of the drive movement of the electric motor 2 via drive gears 16, 16′ to the drive pinions 9, 9′ (cf. FIG. 4). The drive shafts 15, 15′ are arranged on both sides of the electric motor 2 coaxially to the motor shaft 5. In other words the longitudinal shaft directions 17 of drive shafts 15 coincide with the longitudinal direction 12 of the motor shaft. To drive the drive gears 16 the drive shafts 15, 15′ are embodied in the form of worm drive shafts. In addition each drive shaft 15, 15′ has a radial axial bearing in the form of a ball race 20, 20′ and a radial bearing in the form of a cup bearing 18, 18′. Arranged on the drive shafts 15, 15′ are ring magnets 19, 19′ for Hall sensors, which are used for position control and specification of the drive shafts 15′. Because the Hall sensors are not arranged in or directly on the electric motor 2, but on (decouplable) drive elements, it is possible not to lose the (relative) positions of the drive 1 stored in the motor electronics even with mechanical play of the drive elements or with feedback effects from the movement mechanics of the sliding roof. The positioning of the ring magnets 19, 19′ specifically on the drive shafts 15, 15′ leads in this arrangement to position control being very simple (for example by comparison with an arrangement on the drive gears 16, 16′) and is still performed reliably even during or after the coupling processes.

The two movable clutch sections 11, 11′ connected to the motor shaft 5 are connected to each other via a switching yoke 21. The switching yoke 21 consists of a main yoke section 22 running in parallel to the longitudinal axis of the motor shaft 12 which leads through a fixed solenoid 23 and can be moved by the latter in parallel to the longitudinal motor shaft direction 12 in the switching direction 13. Arranged at the two ends of the main yoke section 22 are connecting pieces 24 running at right angles to the longitudinal motor shaft direction 12, at the ends of which are provided attachment claws 25 which connect the movable clutch sections 11 to the switching yoke 21. To this end the attachment claws 25 are inserted into corresponding grooves 26 on the clutch sections 11, cf. FIG. 3.

The solenoid 23 is arranged in parallel to the electric motor 2. It also has a plug connection (not shown) used to supply power to it. The solenoid 23 is preferably controlled by control electronics integrated into the drive (not shown), which is either part of the motor control device or is connected to this device. The solenoid 23 involves a bistable switching system with a coil and two permanent magnets (not shown). This means that the switching yoke 21 can be brought with the aid of the solenoid 23 into two different switching positions. The advantages of a bistable solenoid lie in the fact that an activation in both directions is possible by reversing the coil polarity. Such a solenoid is operated in a pulse mode, so that there is only a low power demand during the switching process. In the latching end positions the power consumption is equal to zero, so that no energy is consumed.

In the exemplary embodiment described here the components are arranged such that in a first switching position of the solenoid 23 the front jaw clutch 11, 14 is completely released and the rear jaw clutch 11′, 14′ is completely engaged, as depicted in FIG. 1. In a second switching position of the solenoid 23 the front jaw clutch 11, 14 is completely engaged and the rear jaw clutch 11′, 14′ is completely released. In a further exemplary embodiment the switching positions can however also be provided such that, in a first switching position the front jaw clutch 11, 14 is completely released and the rear jaw clutch 11′, 14′ is completely engaged (or vice versa), whereas in a second switching position both the front and also the rear jaw clutch is (partly) engaged. With such a part engagement the jaws of the clutch sections 11, 14 or 11′, 14′ do not engage completely, by only partly into each other and yet still guarantee a secure transmission of the drive movement of the electric motor 2.

A latching push-type solenoid with two switching stages can also be used as the solenoid 23 instead of the bistable solenoid with a coil, which can also be referred to a push-type solenoid without a zero position. Here too the lifting movement occurs through an electromagnetic force effect. Two coils are used in such cases. In the end positions when the current is switched off the armature is held by a permanent magnet. After the neutralization of the permanent magnet by a negative current pulse and the simultaneous excitation of the corresponding coil a lifting movement into the other lifting position starts once again.

In a further exemplary embodiment the solenoid 23 involves a system with three switching stages (stable). These switching stages are preferably provided in this case such that in a first switching stage the front jaw clutch 11, 14 and in a second switching stage exclusively the rear jaw clutch 11′, 14′ is engaged, while in a third switching stage, to move the two drive pinions 9, 9′, both jaw clutches are (partly) engaged. This embodiment thus enables not only an alternate, but also a simultaneous transmission of the drive movement to the drive pinions 9, 9′.

If three switching stages are to be provided, a double solenoid is preferably used as the solenoid 23. This is equipped with two coils. Its armature can assume three different positions. Depending on which of the coils is switched on, the armature moves from a central position into one or other of its lifting positions.

In addition to the solenoid systems described, other solenoid systems can of course also be employed, as well as systems based on other action principles. It is for example possible, instead of a solenoid, to employ a servo motor (electric motor with adjustment drives).

Depending on the position of the switching yoke 21 the drive movement of the electric motor 2 is thus transmitted via the motor shaft 5 to one of the two drive shafts 15, 15′ and from there via the drive gears 16, 16′ to the drive pinions 9, 9′. The transmission capacity of the front or of the rear jaw clutch 11, 14 or 11′, 14′ is determined in such cases by the position of the switching yoke 21.

Jaw clutches are used as clutches in the exemplary embodiment shown, cf. FIG. 3. Provided on the fixed and movable clutch sections 11, 14, 11′, 14′ are jaws 27 pointing towards each other, which are matched to each other in their number and size and, in the corresponding position of the switching yoke 21, engage into each other and which make possible a positive fit between the inner clutch sections 11, 11′ and the outer clutch sections 14′ of the jaw clutch. The individual jaws 27 of the clutch sections 11, 14 have starting bevels 28 on their ends pointing towards each other. This facilitates the engagement of the clutch sections 11, 14. Different methods can be employed for the process of engagement A PWM activation of the electric motor 2 has proved to be especially advantageous. The solenoid 23 is switched at a comparatively low speed of the electric motor 2, so that a safe engagement is possible. In this case the starting bevels 28 could also be omitted.

Instead of the jaw clutch however—depending on the application—other, preferably likewise controllable switchable clutch systems could be employed, for example toothed clutches (positive fit) or friction clutches (interference fit).

FIG. 5 illustrates a further exemplary embodiment. This differs from the previously described exemplary embodiments in that there is no switching yoke 21 driven by a solenoid 23 for the two movable clutch sections 14, 14′. Instead each movable clutch section 14, 14′ is provided with a separate switching yoke element 29. Each of these switching yoke elements 29 is able to be driven (independently) by a bistable solenoid in the switching direction 13. The result achieved by this is that both an alternate and also a simultaneous transmission of the drive movement of the electric motor 2 to the drive pinions 9, 9′ is possible, with the clutch sections 11, 14, 11′, 14′ in such case always being able to engage completely into each other.

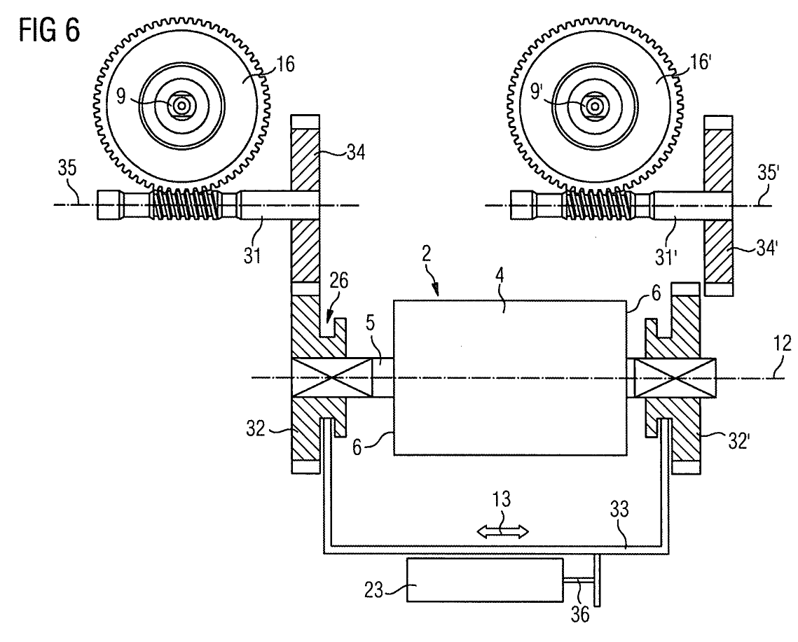

FIG. 6 illustrates a further exemplary embodiment. By contrast with the previous figures, in which the drive shafts 15, 15′ were always arranged coaxially to the motor shaft 5, the two drive shafts 31′ in this case are arranged in parallel offset to the motor shaft 5.

In the example shown, gears 32, 32′ are provided as the movable clutch sections at the two ends of the motor shaft 5, which is once again embodied as a square shaft. In this case the gears 32, 32′, embodied as spur wheels, are once again connected to the motor shaft 5 to allow axial movement. Via a switching yoke 33—which is embodied similar to the switching yoke 21 described above, which does not however pass directly through the solenoid 23, but is actively connected to the solenoid 23 via a connecting section 30—the two movable gears 32 are connected to each other. A movement of the switching yoke 33 which is able to be moved with the aid of the solenoid 23 in parallel to the longitudinal direction of the motor shaft 12 in the switching direction 13 enables these gears 32 to be moved axially on the motor shaft 5, i.e. in the longitudinal direction 12 of the motor shaft. Depending on which of its two switching positions of the solenoid 23 adapts, one of the two movable gears 32 would then engage with a corresponding fixed gear 34, 34′ on one of the drive shafts 31, 31′ provided as a mating unit. In this case the gears 34, 34′ arranged on it are connected fixed in an anti-torque manner to the drive shaft 31, 31′. If a solenoid 23 with three switching stages is again provided, here too not only an alternate, but also a simultaneous transmission of the drive movement of the electric motor 2 to the drive pinions 9, 9′ can take place, if both movable gears 32, 32′ mesh in a center position with the two fixed gears 34, 34′.

The drive shafts 31, 31′ embodied as worm drives are once again connected via drive gears 16, 16′ to the drive pinions 9, 9′.

Naturally it is likewise possible in further exemplary embodiments (not shown) not to arrange the two drive shafts 15, 15′ or 31, 31′ (as shown in FIG. 1 or FIG. 6) coaxially to each other. Thus for example it is possible to arrange the one drive shaft 15 or 31 in parallel offset to the motor shaft 5 (as in FIG. 6) and the other drive shaft 15′ or 31′ transverse to the motor shaft 5. Obviously a combination of a coaxial arrangement of motor shaft 5 and drive shaft 15, 31 (as in FIG. 1, 7) with a (parallel) offset arrangement is possible (as in FIG. 6). Given the appropriate clutch sections, such as beveled gears for example—the drive shafts 15, 15′, 31, 31′ can also be provided in any way and at different angles to the motor shaft 5 and thus assume any given position.

The arrangement of the drive shafts in (basically) any given manner (the longitudinal direction 17, 17′, 35, 35′ of the drive shafts 15′, 31, 31′ can thus enclose any angle with the longitudinal direction of the motor shafts) enables the design of the drive 1 to be varied. Very compact designs are thus possible. Since no restrictions are imposed on the choice of the clutch sections (jaw clutches, gearwheels, . . . ), and with suitable selection of the clutch types the arrangement of the drive shafts 15, 31 is also able to be freely selected, the drive system according to various embodiments can be provided in a diversity of designs and variants, with a universal application in all possible areas of a motor vehicles and beyond being possible.

The drive 1 is preferably embodied such that—for example during braking maneuvers or vehicle break-ins—no unintentional movement of the roof is possible. To this end the drive pinions 9, 9′ can—if necessary—be mechanically held in the released state. For this purpose the drive pinions 9, 9′ and/or the drive gears 16 and/or the drive shafts 15, 31 and such like are designed to be self-locking. In such cases account is also taken of the fact that the electric motor 2 in the released state cannot exert any further movement-inhibiting effect on the drive pinions 9, 9′.

1. A drive for use in a motor vehicle, comprising:
a motor, with at least two drive shafts for moving drive pinions, and
a transmission arranged between the motor and the drive shafts for optional transmission of the drive movement of the motor to the drive pinions, wherein the transmission comprises a number of switchable clutches and at least one switching element for simultaneously changing the transmission capacity of one or more clutches.

2. The drive according to claim 1, wherein clutch sections, of which the transmission capacity can be changed, are arranged at two points of a motor shaft at a distance from each other.

3. The drive according to claim 2, wherein the motor shaft is arranged coaxially to at least one drive shaft.

4. The drive according to claim 2, wherein the motor shaft is arranged offset to at least one drive shaft.

5. The drive according to claim 1, comprising a switching element operating with magnetic force.

6. The drive according to claim 5, wherein the switching element is a solenoid.

7. The drive according to claim 6, wherein the solenoid constitutes a bistable switching system.

8. The drive according to claim 7, wherein the solenoid is operated in a pulse mode.

9. The drive according to claim 6, wherein the solenoid is arranged in parallel to the motor.

10. The drive according to claim 6, wherein the solenoid is controlled by control electronics integrated into the drive.

11. A drive for use in a motor vehicle, comprising:
a motor having a drive shaft exiting on opposing ends of the motor,
a first transmission arranged between one end of the motor shaft and a first drive shaft, and
a second transmission arranged between another end of the motor shaft and a second drive shaft, wherein each transmission comprises a switchable clutch and at least one switching element for either engaging the clutch at the first or second drive shaft.

12. The drive according to claim 11, wherein clutch sections, of which the transmission capacity can be changed, are arranged at two points of the motor shaft at a distance from each other.

13. The drive according to claim 12, wherein the motor shaft is arranged coaxially to at least one drive shaft.

14. The drive according to claim 12, wherein the motor shaft is arranged offset to at least one drive shaft.

15. The drive according to claim 11, comprising a switching element operating with magnetic force.

16. The drive according to claim 15, wherein the switching element is a solenoid.

17. The drive according to claim 16, wherein the solenoid constitutes a bistable switching system.

18. The drive according to claim 17, wherein the solenoid is operated in a pulse mode.

19. The drive according to claim 16, wherein the solenoid is arranged in parallel to the motor.

20. The drive according to claim 16, wherein the solenoid is controlled by control electronics integrated into the drive.
